(19) United States
(12) Patent Application Publication
(10) Pub. No.: US 2024/0129252 A1
(43) Pub. Date: Apr. 18, 2024

(54) Technique for Message Handling in an Industrial Control Procedure

(71) Applicant: Telefonaktiebolaget LM Ericsson (publ), Stockholm (SE)

(72) Inventors: Csaba Györgyi, Nyiregyhaza (HU); Sandor Laki, Budapest (HU); Károly Kecskeméti, Kiskörös (HU); Gergely Pongrácz, Budapest (HU); Géza Szabó, Kecskemét (HU)

(21) Appl. No.: 18/547,418

(22) PCT Filed: Mar. 17, 2021
(86) PCT No.: PCT/EP2021/056810

§ 371 Date: Aug. 22, 2023

(51) Int. Cl. H04L 47/32; H04L 67/12; H04L 67/564

(52) U.S. Cl. CPC H04L 47/32; H04L 67/12; H04L 67/564

(57) ABSTRACT

A technique for handling messages generated in an industrial control procedure by a first device for being transmitted via a communication network towards a second device is presented, wherein the first device is one of a field device and a field device controller and the second device is the other one of the field device and the field device controller. A method implementation of the technique comprises intercepting a first message generated by the first device, wherein the first message is intercepted before the communication network towards the second device, and wherein the first message has a first message content. The method also comprises storing the first message content and forwarding the first message content on the communication network towards the second device. Further, the method comprises intercepting at least one second message generated by the first device, wherein the at least one second message is intercepted before the communication network towards the second device, and wherein the at least one second message has a second message content. Further still, the method comprises determining if the second message content matches the stored first message content, and if the second message content matches to the stored first message content, preventing the matching message content from again being forwarded on the communication network towards the second device.

### TECHNICAL FIELD

The present disclosure generally relates to industrial automation. In particular, a technique is presented for handling messages generated in an industrial control procedure by a first device for being transmitted via a communication network to a second device, wherein one of the first device and the second device is a field device and the other of the first device and the second device is a field device controller. The technique may be implemented in the form of a method, a computer program product, an apparatus and an apparatus system.

### BACKGROUND

In industrial automation, field devices and field device controllers in an industrial process domain (e.g., a robot cell) have previously been interconnected via wired field buses. Nowadays, there is a trend to control field devices by a field device controller that is connected to the field devices via a communication network. The field device controller may, for example, be deployed in a computing cloud as taught in US 2013/0212214 A1, US 2014/0047107 A1 or EP 2 933 976 B1. In such a scenario, messages generated by the controller in the computing cloud can be transmitted to the industrial process domain using a wireless or hierarchically structured wired communication network that replaces at least a portion of the conventional field bus.

Existing communication protocols for industrial automation (e.g., EtherCAT or ProfiNet) have been developed for situations in which the controller is situated in the industrial process domain and connected to the field devices via a field bus. These protocols assume that data transmission from the controller to the field devices is reliable and has no substantial delay. This is a fair assumption given the fact that field buses are not impacted by the challenges of wireless data transmission, such as packet loss, jitter, wireless spectrum availability, re-transmission delay, and proper resource allocation. Wireless data transmission and data transmission over a hierarchically structured wired communication network, on the other hand, introduce laten-cy and, thus, negatively impact the deterministic behaviour of the industrial control procedure compared to field bus-based solutions.

Some communication protocols for industrial automation such as ProfiNet define a cyclic transmission of real-time messages at a predefined timing from typically 1 millisecond to a few seconds. In case a message source (i.e., a particular field device or its controller) has no new message content to transmit at a given point in time defined by the predefined timing, it simply re-transmits the message content of the previous message.

In some configurations of ProfiNet and similar communication protocols, message reception is not acknowledged by the message destination to the message source. For this reason a mechanism is defined according to which the message destination monitors reception of an awaited message according to the predefined timing. In this way, the message destination gains sufficient and, in the ideal case, real-time knowledge about any delayed or lost messages and associated transmission issues. Already a few (e.g., 3) outstanding consecutive messages imply a serious transmission problem and may lead to drastic actions, such as stopping an entire robot cell.

In cloud-based and similar implementations of field device controllers, a single or multiple controller instances can easily control a significant number of field devices in an industrial process domain. An increasing number of controllers and field devices also leads to an increased number of messages being transmitted via the communication network interconnecting those entities. On the other hand, transmission resources are scarce in wireless and hierarchically structured wired communication networks.

### SUMMARY

There is a need for a resource-efficient utilization of a communication network that interconnects a field device controller with one or more field devices.

According to a first aspect, a method of handling messages generated in an industrial control procedure by a first device for being transmitted via a communication network towards a second device is presented, wherein the first device is one of a field device and a field device controller and the second device is the other one of the field device and the field device controller. The method comprises intercepting a first message generated by the first device, wherein the first message is intercepted before the communication network towards the second device, and wherein the first message has a first message content. The method also comprises storing the first message content and forwarding the first message content on the communication network towards the second device. Further, the method comprises intercepting at least one second message generated by the first device, wherein the at least one second message is intercepted before the communication network towards the second device, and wherein the at least one second message has a second message content. Further still, the method comprises determining if the second message content matches the stored first message content, and if the second message content matches to the stored first message content, preventing the matching message content from again being forwarded on the communication network towards the second device.

The messages may take the form of data packets or data frames. In such an implementation, the message content many be defined by packet data or frame data. The message may additionally comprise a message header (e.g., a packet header or a frame header).

Preventing the matching message content from again being forwarded on the communication network may result in an output data rate onto the communication network that is lower than an input data rate defined by the intercepted messages. As such, transmission resources of the communication network can be saved. Preventing the matching message content from again being forwarded on the communication network may comprise at least one of discarding (e.g., dropping) the at least one second message, returning the at least one second message to the first device (using, e.g., message replication and, optionally, modifying one or both of a message header and content) and refraining from transmitting a new message containing the matching method content on the communication network towards the second device.

If the second message content does not match the stored first message content, the method may comprise forwarding the second message content on the communication network towards the second device.

The intercepted messages may be received from the first device in accordance with a predefined first timing. The first device may be configured to re-transmit the first message content in the second message (that is intercepted by the apparatus) in case no new message content has become available at the first device at a point in time when the first timing requires the first device to transmit the second message. In case of a real-time processing scheme, intercepting, by the apparatus, the messages that have been transmitted by the first device in accordance with the first timing may trigger returning, by the apparatus, the messages to the first device, such that the returned messages also conform to the first timing (albeit with possibly a slight temporal offset caused by the real-time processing).

In case new message content has become available at the first device at a point in time when the first timing requires the first device to transmit the second message, the first device may be configured to transmit the new message content instead of the first message content in the second message.

The method may comprise determining, based on the intercepted messages, if message reception from the first device conforms to the first timing, and triggering an error condition detection at the second device in case message reception from the first device does not conform to, in particular falls behind, the first timing. Triggering the error condition may comprises transmitting an error notification (e.g., setting a bit or flag) in a notification message on the communication network towards the second device. The notification message may include for each of one or more first devices either an error notification or an aliveness notification (e.g., in the form of a bitmap).

The method may comprise generating at least one connection test message and transmitting the at least one connection test message on the communication network. The at least one connection test message may be transmitted at least during a period of time in which the matching message content is prevented from being forwarded on the communication network. In some variants, the notification message takes the role of the connection test message.

The at least one connection test message may be transmitted in accordance with the first timing. The at least one connection test message may have a first data volume that is less then a second data volume of the at least one second message.

Forwarding the first message content on the communication network may comprise forwarding the first message, or transmitting a new message comprising the first message content, on the communication network.

The method steps may be performed by an apparatus coupled via a fieldbus to the first device. The apparatus may be configured as a switch, in particular a programmable switch.

Determining if the second message content matches the stored first message content may comprise calculating a first hash over one of the first message and the first message content, calculating a second hash over a corresponding one of the second message and the second message content, and comparing the first hash with the second hash.

In some variants, a third message with a third message content had been intercepted by the apparatus before the first message, wherein the third message content had been stored by the apparatus. In such variants, at least one of the steps of storing and forwarding is performed in response to determining that the first message content does not match stored third message content.

The method may comprise receiving, via the communication network, an acknowl-edgement message relating to the first message content.

The method may comprise transmitting a fourth message to the first device in response to at least one of the first message and the second message. The fourth message may be a returned (e.g., replicated) version of the first message or the second message.

The first device may be configured to detect an error condition if one or more messages are not received from the second device according to a predefined second timing. The method may comprise transmitting (the) at least one fourth message to the first device in accordance with the second timing. In some implementations, the first timing corresponds to the second timing, so that transmitting the fourth message to the first device in response to receipt of at least one of the first message and the second message (e.g., by returning in real-time the corresponding message upon interception) prevents the first device from detecting an error condition.

The method may comprise intercepting a fifth message received via the communication network, wherein the fifth message has a fifth message content that has been generated by the second device, storing the fifth message content, transmitting the fifth message content to the first device, and re-transmitting the stored fifth message content to the first device in accordance with the second timing.

The method of the first aspect may comprise receiving, via the communication network, a fourth message content that has been generated by the second device, storing the fourth message content, and generating the fourth message to include the stored fourth message content.

A second aspect is directed at a method of handling messages generated in an industrial control procedure by a first device for being transmitted via a communication network towards a second device, wherein the first device is one of a field device and a field device controller and the second device is the other one of the field device and the field device controller, and wherein the second device is configured to detect an error condition if one or more messages are not received network from the first device according to a predefined timing. The method comprises intercepting a first message received via the communication network, wherein the first message has a first message content that has been generated by the first device, storing the first message content, forwarding the first message content to the second device, and re-transmitting the stored first message content to the second device in accordance with the timing.

The re-transmission may be triggered by a third message received from the first device in accordance with the timing.

Re-transmitting the first message content may compensate for a second message having a second message content matching the first message content not being received via the communication network in accordance with the timing. Re-transmitting the first message content to the second device may result in an output data rate towards the second device being higher than an input data rate on the communication network. Re-transmitting the first message content may comprise re-transmitting the first message or transmitting a new message comprising the first message content.

The second device (and also the first device) may be configured to detect the error condition if a number n>1 of successive messages is not received according to the timing. In some cases, the number n may equal 2, 3 or 4.

The first device and the second device may have the same timing or different tim-ings. The timing may be pre-negotiated between the first device and the second device.

The method of the second aspect may comprise receiving, via the communication network, a notification message indicative of message generation by the first device not conforming to, in particular falling behind, the timing, and causing an error condition detection by the second device. Causing the error condition detection by the second device may comprise stopping re-transmission of the stored first message content (and, optionally, stopping transmission of any messages to the second device) to trigger non-conformance of message reception at the second device with the timing.

The method of the second aspect may comprise monitoring the communication network for receipt of one or more connection test messages and, optionally, causing an error condition detection by the second device in case the one or more connection test messages are not received as expected. Causing the error condition detection by the second device may comprise stopping re-transmission of the stored first message content (and, optionally, stopping transmission of any messages to the second device) to trigger non-conformance of message reception at the second device with the timing.

The method of the second aspect may comprise intercepting a second message received via the communication network, wherein the second message has been generated by the first device and has a second message content, determining if the second message content corresponds to the stored first message content, and, if the second message content does not correspond to the stored first message content, stopping re-transmission of the first message to the second device and transmitting the second message content to the second device. The method may further comprise storing the second message content and re-transmitting the stored second message content to the second device in accordance with the timing.

The steps of the second method aspect may be performed by an apparatus coupled via a fieldbus to the second device. The apparatus may take the form of a switch, such as a programmable switch.

In the method of any of the above aspects, the timing may define at least one of a cyclic message transmission by the first device and a cyclic message reception by the second device. Message generation by the first device may comply with the PROFINET standard, in particular with one or both of IEC 61158-1:2019 and IEC 61784-2:2019.

In all method aspects, the transmission network may comprise at least one of a wireless transmission network and a wired communication network, in particular a hierarchically structured wired communication network. The industrial control procedure may relate to control of a robot cell. The message content may relate to one of a control command generated by the field device controller for the field device and status information generated by the field device for the field device controller.

The method of any aspect may be performed by a programmable data processing circuit separate from either one of the first device and the second device. The circuit may be realized as a switch.

Also provided is a computer program product comprising program code portions that, when executed by at least one processor, cause the at least one processor to perform the steps of any of the method aspects presented herein. The computer program product may be stored on a computer readable recording medium, such as a semiconductor memory, a CD-ROM, and so on.

Another aspect is directed at an apparatus configured to handle messages generated in an industrial control procedure by a first device for being transmitted via a communication network towards a second device, wherein the first device is one of a field device and a field device controller and the second device is the other one of the field device and the field device controller. The apparatus is configured to intercept a first message generated by the first device, wherein the first message is intercepted before the communication network towards the second device, and wherein the first message has a first message content. The apparatus is further configured to store the first message content and forward the first message content on the communication network towards the second device. The apparatus is further configured to intercept at least one second message generated by the first device, wherein the at least one second message is intercepted before the communication network towards the second device, and wherein the at least one second message has a second message content. Further still, the apparatus is configured to determine if the second message content matches the stored first message content, and if the second message content matches to the stored first message content, prevent the matching message content from again being forwarded on the communication network towards the second device.

A still further aspect is directed at an apparatus configured to handle messages generated in an industrial control procedure by a first device for being transmitted via a communication network towards a second device, wherein the first device is one of a field device and a field device controller and the second device is the other one of the field device and the field device controller, and wherein the second device is configured to detect an error condition if one or more messages are not received from the first device according to a predefined timing. The apparatus is configured to intercept a first message received via the communication network, wherein the first message has a first message content generated by the first device, store the first message content, forward the first message content to the second device, and re-transmit the stored first message content to the second device in accordance with the timing.

Moreover, a system comprising the two apparatuses is presented, wherein the two apparatuses are either arranged on the same site or on opposite sites from the perspective of the communication network.

### BRIEF DESCRIPTION OF THE DRAWINGS

Further aspects, details and advantages of the present disclosure will become apparent from the detailed description of exemplary embodiments below and from the drawings, wherein:

FIG. 1 illustrates a network system embodiment of the present disclosure;

FIG. 2A illustrates a further network system embodiment of the present disclosure;

FIG. 2B illustrates a message handling apparatus embodiment of the present disclosure;

FIGS. 3A & B illustrate method embodiments of the present disclosure;

FIG. 4A-D illustrate signalling diagrams according to embodiments of the present disclosure; and

FIGS. 5 & 6 illustrate message processing pipelines according to embodiments of the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on specific Radio Access Network (RAN) types such as 5^{th} Generation (5G) RANs, also called New Radio (NR) RANs, the present disclosure can also be implemented in the context of other RAN types (e.g., 4G RANs). While some of the embodiments are explained using ProfiNet as an exemplary industrial process communication protocol, the present disclosure can also be implemented using any other industrial process communication protocol such as EtherCAT.

Those skilled in the art will further appreciate that the steps, services and functions explained herein may be implemented using individual hardware circuitry, using software functioning in conjunction with a programmed micro processor or general pur-pose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numer-als denote the same or similar components.

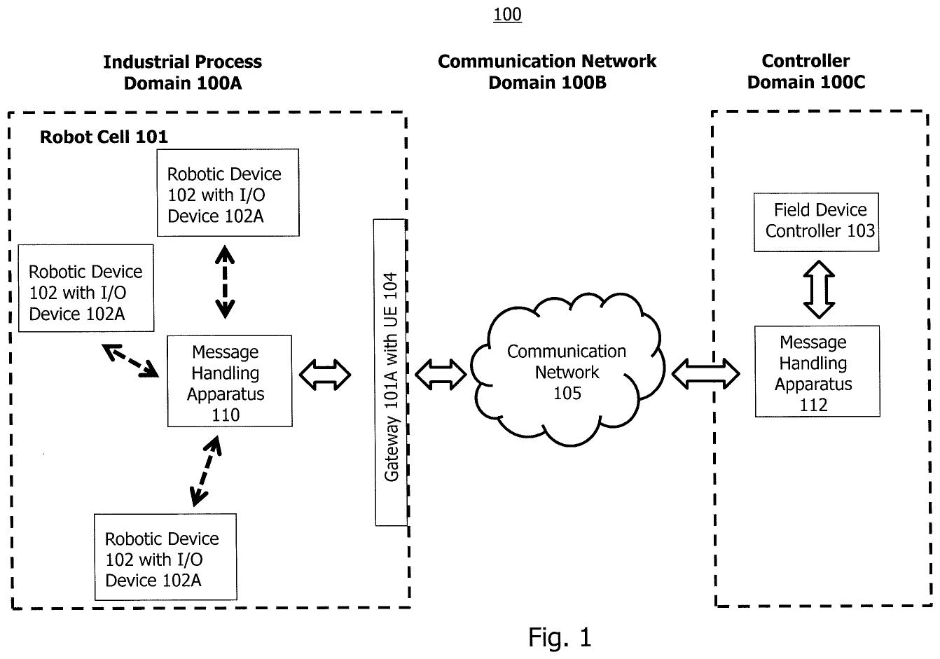

FIG. 1 illustrates a first embodiment of a network system 100 in which the present disclosure can be implemented. As shown in FIG. 1, the network system 100 comprises an industrial process domain 100A, a communication network domain 100B and a controller domain 100C.

The industrial process domain 100A comprises a robot cell 101 as one example of an industrial process in need of control. The present disclosure could, of course, also be implemented in the context of chemical process control or control of any other industrial process. The robot cell 101 comprises multiple robotic devices 102 each having at least one dedicated local controller, also called Input/Output (I/O) device 102A herein. Each robotic device 102, such as a robot arm movable within various degrees of freedom, may comprise multiple actuators (e.g., servos). Multiple robotic devices 102 within the robot cell 101 may collaboratively work on the same task (e.g., on the same work product).

Each I/O device 102A comprises or represents, from the perspective of an industrial process communication protocol such as ProfiNet, a field device within the industrial process domain 100A. The I/O devices 102A illustrated in FIG. 1 are centrally controlled by a field device controller 103 in the controller domain 100C. The I/O devices 102A may have components, such as software and/or hardware interfaces, function-ally located on OSI level 1 (physical level). The I/O devices 102A may comprise hardware Programmable Logic Controllers (PLCs), discrete Proportional-Integral-Derivative (PID) controllers, or similar devices.

In the embodiment of FIG. 1, a central gateway 101A within the robot cell 101 is associated with a communication endpoint 104 that provides an interface to the communication network domain 100B. Such a communication endpoint 104 is in some communication standards referred to as User Equipment (UE) and will in the following, without limitation, also be referred to as UE 104.

The communication network domain 100B hosts a communication network 105 or a portion thereof. The communication network 105 comprises, for example, a cellular and/or non-cellular RAN or a complex (e.g., hierarchically structured) wired network. The communication network domain 100B may in particular comprise a RAN with one or more base stations and/or one or more wireless access points that enable a wireless communication between the communication endpoint (UE) 104 in the robot cell 101 and the RAN. In some variants, the controller domain 100C likewise comprises such a communication endpoint (not shown) for wireless communication with the RAN. For example, the communication network domain 100B may comprise a 5G-based communication network 105 compliant with the 3GPP standards according to Release R15, such as TS 23.503 V15.1.0 (2018-3) or later.

The controller domain 100C comprises the field device controller 103 that controls the I/O devices 102A. The controller 103 is, for example, composed of cloud computing resources (e.g., as a software-implemented PLC) or configured as a hardware-implemented PLC.

Messages, also called packets or frames, of a industrial process communication protocol are transferred on a virtual field bus section that stretches through the communication network domain 100B. The protocol messages are tunneled through the communication network 105.

Evidently, the communication network domain 100B, in particular when implemented in a wireless manner (e.g., as a 5G RAN), has limited transmission resources. It has been found that such limited resources are unnecessarily burdened by ProfiNet and similar communication protocols that rely on a cyclic message exchange between the I/O devices 102A and the controller 103 based on a predefined timing. It has in particular been found that the re-transmission of previously transmitted message content in case no new message content has become available at the next transmission instant by one of the I/O devices 102A or the controller 103 does not have to be sent over the communication network domain 100B in case a suitably-configured message handling apparatus 110, 112 (see FIG. 1) is deployed in each of the industrial process domain 100A and the controller domain 100C. The apparatus 110 and the apparatus 112 may have may the same configuration in regard to hardware and software (i.e., the same programming) and may be configured as a Programmable Packet Processing Circuit (PPPC).

At least in the industrial process domain 100A, the message handling apparatus 110 may be coupled via a wired field bus to each of the I/O devices 102A. In some variants, the message handling apparatus 110 is coupled via a wired connection, not necessarily a field bus, to the gateway 101A.

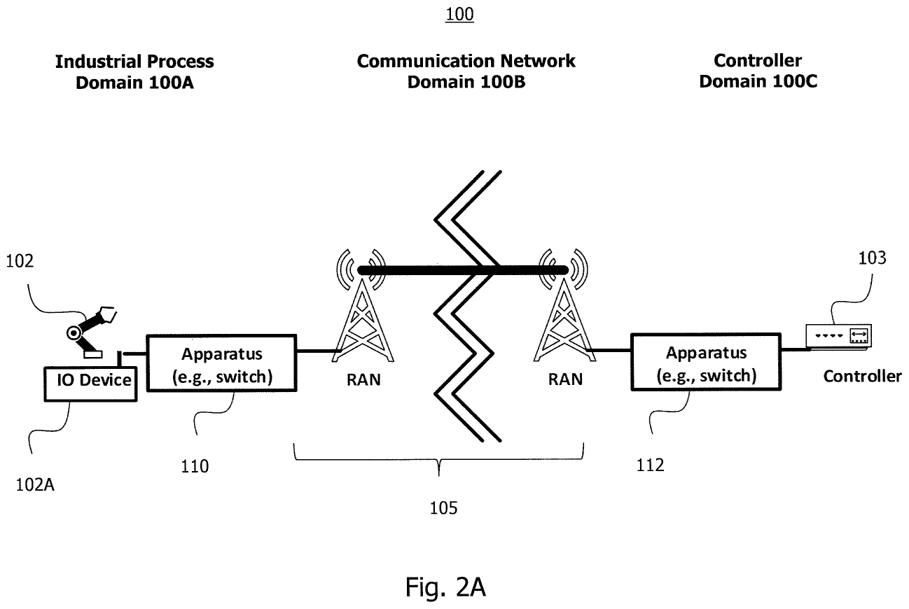

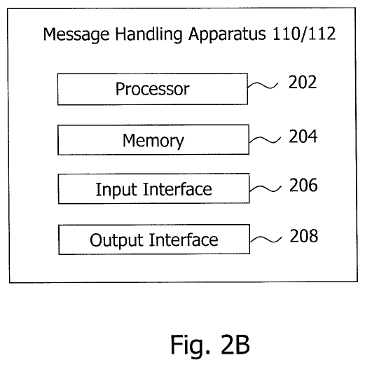

Details of the apparatus 110 in the industrial process domain 100A and the apparatus 112 in the controller domain 100C now will be described with reference to FIGS. 2A and 2B below.

FIG. 2A illustrates a network system 100 that may correspond to the one discussed above with reference to FIG. 1. It is assumed here that both the industrial process domain 100A and the controller domain 100C are wirelessly coupled via a respective UE (not shown) to a respective base station belonging to a local RAN of the communication network 105.

Messages are exchanged between the industrial process domain 100A and the controller domain 100C as follows. The robotic device 102 (here: a robotic arm) is configured to be controlled by its associated I/O device 102A based on control commands received in messages generated by the controller 103 in the controller domain 100C. Moreover, status information acquired by the I/O device 102A from the robotic device 102 is communicated in messages to the controller domain 100C. The controller 103 is configured to receive the status information from the I/O device 102A and to generate the control commands for the robotic device 102 based there-on. Processing of the status information by the controller 103 may be performed in the context of inverse kinematics, in a PID control context, in a robot cell security context or in the context of performance monitoring and control. The controller 103 may be realized as a software-based PLC running in a computing cloud (e.g., a pub-lic, private or edge cloud) or as a hardware PLC.

In the exemplary embodiment of FIG. 2A, each message handling apparatus 110, 112 may be configured as a programmable hardware switch. In some variants, each apparatus 110, 112 is programmable in a programming language such as P4 that permits a description of a message processing pipeline in a protocol-independent manner. Protocol-independent network programming makes it possible to utilize switches beyond mere message forwarding operations. Rather, the switches can also take part in calculations on the application level during the ongoing communication, which is also called in-network computing and will now be described in greater detail.

FIG. 2B illustrates an embodiment of the message handling apparatus 110 or the message handling apparatus 120 of FIG. 1 or FIG. 2A. Each apparatus 110, 120 comprises a processor 202 and a memory 204 coupled to the processor 202. The processor may be configured as a Central Processing Unit (CPU) and may comprise one or more CPU ports, as is generally known in the art.

Each apparatus 110, 120 further comprises at least one input interface 110A and at least one output interface 110B. The memory 204 stores program code that controls operation of the processor 202. Moreover, the memory 204 may store data that becomes available to the apparatus 110 or the apparatus 120 during operation thereof.

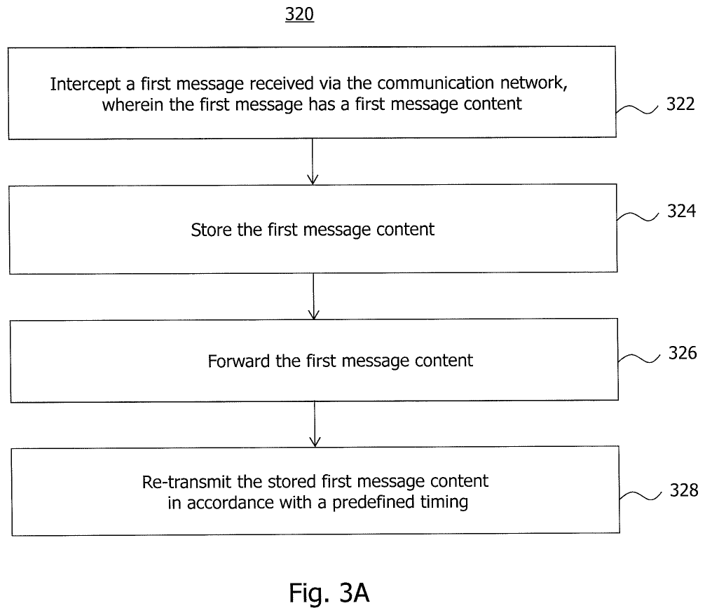

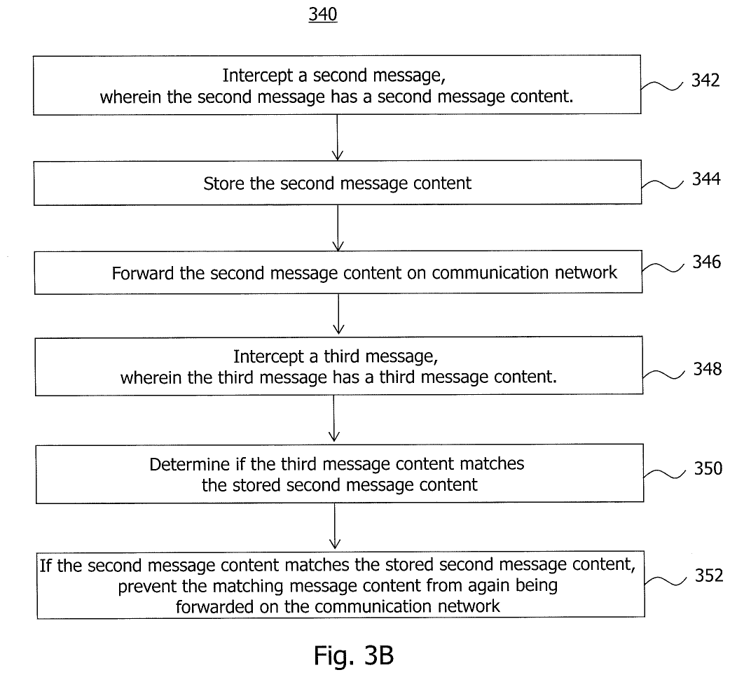

Operation of the apparatus 110 of FIGS. 1, 2A and 2B in accordance with a first method embodiment will now be described with reference to flow diagram 320 of FIG. 3A. In the first method embodiment illustrated in FIG. 3A, it is assumed that the I/O device 102A is configured to detect an error condition if one or more messages (e.g., data packets) are not received from the controller 103 according to a predefined timing (e.g., in a cyclic manner and at an interval of a particular number of milliseconds or seconds).

Operation of the apparatus 110 in accordance with the first method embodiment comprises intercepting, in step 322, a first message (e.g., a first data packet) received via the communication network 105, wherein the first message has a first message content (e.g., a control command) that has been generated by the controller 103. The apparatus 110 is further configured to store, in step 324, the first message content in the memory 204 and to forward, in step 326, the first message content to the I/O device 102A. The term “forwarding” in regard to message content is to be understood broadly and includes, for example, the transmission of message content that has previously been stored locally by the apparatus 110. Such stored message content may, for example, be forwarded in a message newly generated by the apparatus 110. In step 328, the apparatus 110 re-transmits (“re-forwards”) the stored first message content to the I/O device 102A in accordance with the predefined timing.

The re-transmitting step 328 is triggered locally in the industrial process domain 100A and mimics the transmission timing of the controller 103 as expected by the I/O device 102A (under the assumption that the message content has not changed since the last transmission instant). As such, detection of an error condition by the I/O device 102A is avoided. At the same time, the re-transmitting step 328 makes it obsolete to send the first message content once more via the communication network 105, thus saving on transmission resources in the communication network 105. Re-transmitting the first message content to the I/O device 102A may result in an output data rate on the output interface 206 towards the I/O device 102A being higher than an input data rate on the input interface 206 towards the communication network 105.

Operation of the apparatus 110 in accordance with a second method embodiment will now be described with reference to flow diagram 340 of FIG. 3B. The first and second method embodiments of FIGS. 3A and 3B, respectively, may be performed in parallel (e.g., such that individual steps of both embodiments are interleaved).

The apparatus 110 is configured to intercept, in step 342, a second message (e.g., a data packet) generated by the I/O device 102A. The second message is intercepted in the industrial process domain 102A (e.g., at the site of the I/O device 102A) and before the communication network 105. The intercepted second message has a second message content (e.g., status information), which, in step 344, is stored in the memory 204. The apparatus 110 is further configured to forward, in step 346, the second message content via the communication network 105 towards the controller 103. Steps 344 and 346 may be performed in any order.

Further, the apparatus 110 is configured intercept, in step 348, at least one third message that was generated by the I/O device 102A and comprises a third message content. The at least one third message is intercepted before the communication network 105. Further still, the apparatus 110 is configured to determine, in step 350, if the third message content matches the stored second message content (i.e., if the second message content is re-transmitted by the I/O device 102A). If it is found that the third message content matches to the stored second message content, the apparatus 110, in step 352, prevents the matching message content from again being forwarded on the communication network 105 (i.e., via the communication network domain 100B) towards the controller 103. Preventing the matching message content from again being forwarded on the communication network 105 may result in an output data rate at the output interface 208 towards the communication network 105 that is lower than an input data rate on the input interface 206 (as defined by the intercepted messages). As such, transmission resources in the communication network 105 can be saved.

The apparatus 112 in the controller domain 100C may be configured to operate as described above with reference to FIGS. 3A and 3B, wherein the roles of the I/O device 102A and the controller 103 are exchanged.

Moreover, the apparatus 110 and the apparatus 112 may co-operate such that the apparatus 110 performs the method of FIG. 3B and the apparatus 112 performs the method of FIG. 3A (or vice versa), meaning that the second message content forwarded by the apparatus 110 (in a message) in step 346 via the communication network 105 towards the controller 103 is intercepted by the apparatus 112 in step 322 to obtain the first message content (or vice versa). The re-transmitting step 328 locally performed by the apparatus 112 in the controller domain 100C then makes it obsolete for the remote apparatus 110 to re-transmit the first message content via the communication network domain 100B towards the controller 103, which permits the apparatus 110, in step 352, to prevent the first message content from again being forwarded via the communication network domain 100B towards the controller 103.

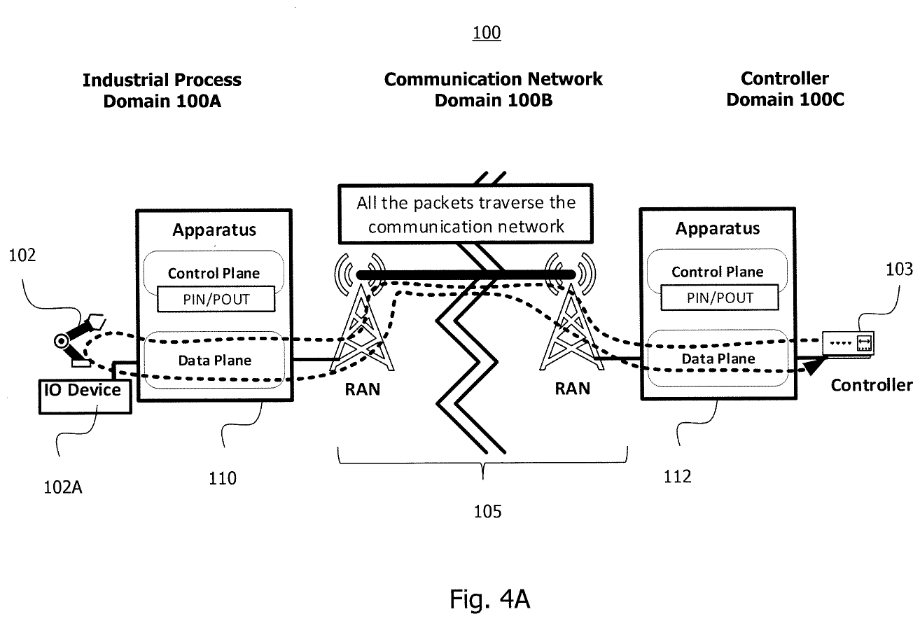

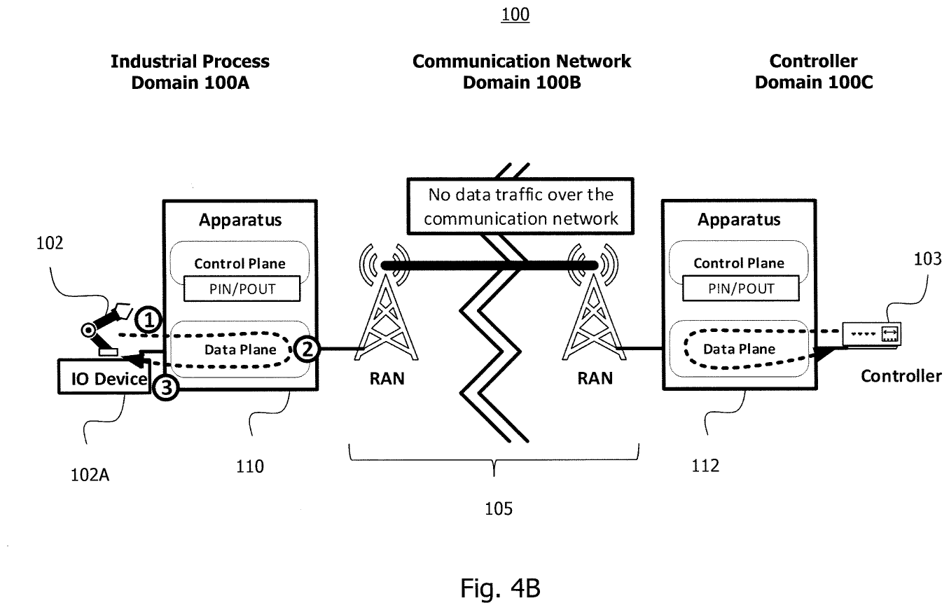

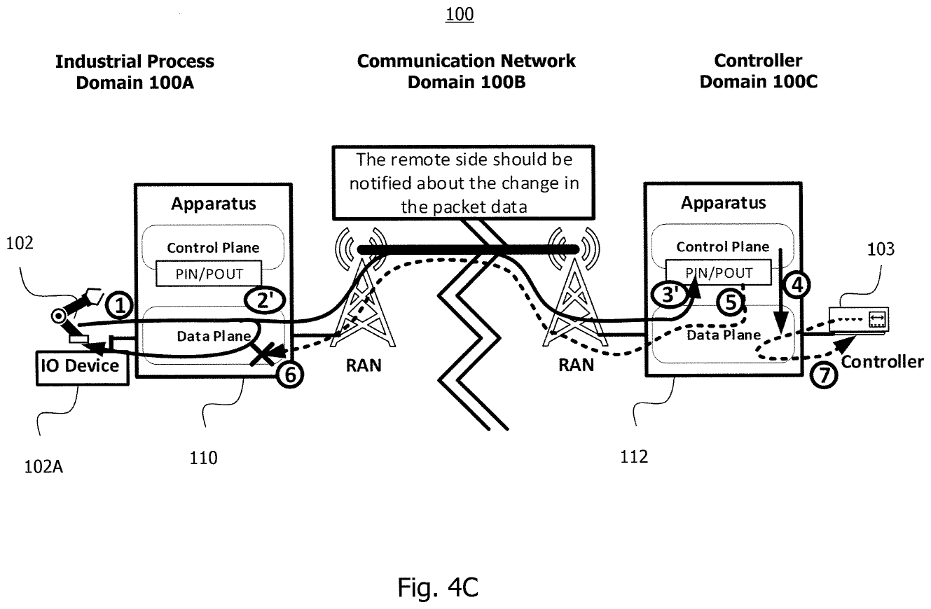

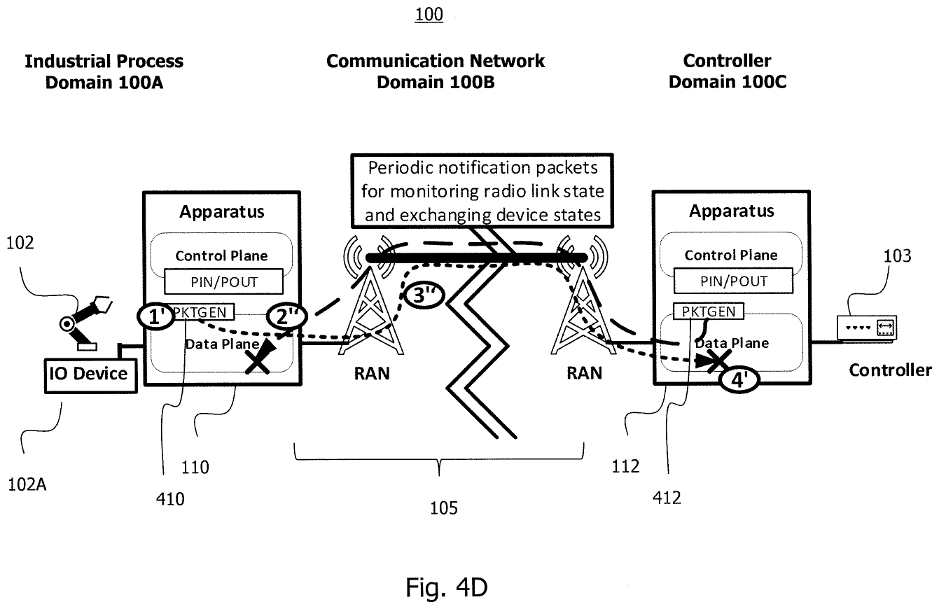

In the following, more detailed embodiments of the present disclosure will be described with reference to FIGS. 4A to 4D, 5 and 6, wherein the same reference nu-merals as used in FIGS. 1 to 3B will be used to denote the same or similar components. The network system 100 in FIGS. 4A to 4D is exemplarily configured as discussed above with reference to the network system 100 of FIG. 2A.

It will in the following embodiments be assumed that the message handling apparatus 110 and the message handling apparatus 112 are two (e.g., P4-programmable) switches and that the industrial communication protocol used for communication between the I/O device 102A and the controller 103 is compliant with the ProfiNet specifications (e.g., one or both of IEC 61158-1:2019 and IEC 61784-2:2019).

The apparatus 110 and the apparatus 112 each implement a data plane and a control plane (see FIGS. 4A to 4D). The data plane is configured to process messages that take the form of data packets (also called frames in the ProfiNet specifications) each having a packet header and packet data (“payload”). The packet data correspond to the message content of, for example, FIGS. 3A and 3B. The packet format is the same in both directions (i.e., regardless of the data packet originating at the I/O device 102A or at the controller 103). The control plane is in charge of writing and re-writing registers, tables and other memory locations within the memory 204 (see FIG. 2B) for being read by the data plane.

FIG. 4A illustrates a real-time communication procedure between the I/O device 102A and the controller 103, in which the data planes of the apparatus 110 and the apparatus 112 are set to transparently forward any data packets received from the local packet source 102A, 103 or, via the communication network domain 100B, from the remote packet source 103, 102A.

In the communication procedure illustrated in FIG. 4A by a dashed arrow, the controller 103 sends a data packet with a control command to the I/O device 102A, which implements the control command to control the associated robotic device 102 and sends a data packet with status information about the robotic device 102 to the controller 103. As explained above, data packet transmission by each of the I/O device 102A and the controller 103 follows a predefined timing (that may be negotiated between the I/O device 102A and the controller 103 in advance). Therefore, each of the I/O device 102A and the controller 103 expects to receive a data packet from the its remote counterpart 103, 102A in accordance with this predefined timing and de-tects an error condition if a certain number of consecutive data packets (e.g., 3) is not received from the remote counterpart 103, 102A as expected. This configuration of the I/O device 102A and the controller 103 requires a re-transmission of previously transmitted packet data in case no new packet data (e.g., new status information or a new control command) have become available when it is time to transmit the next data packet.

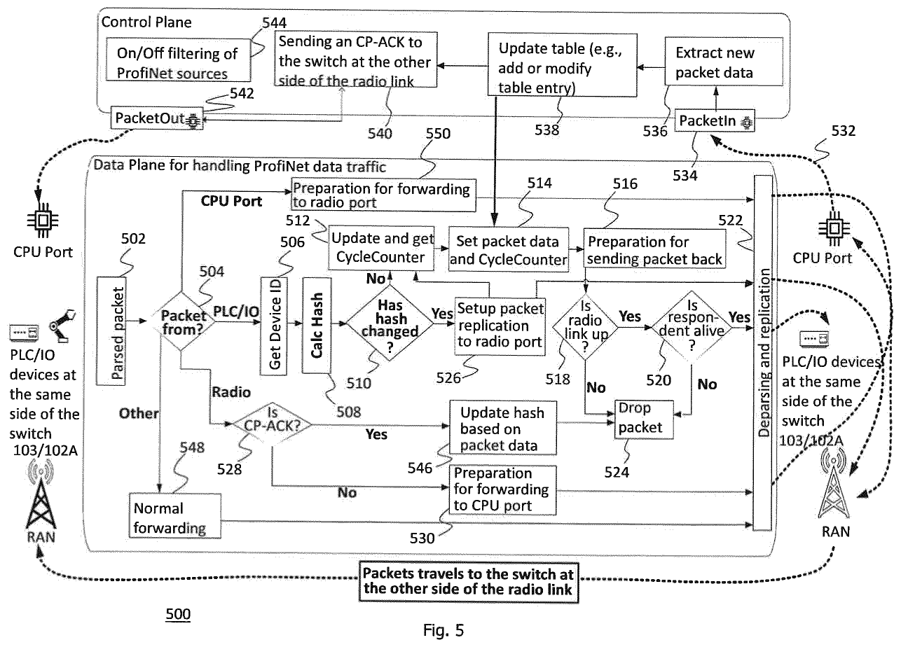

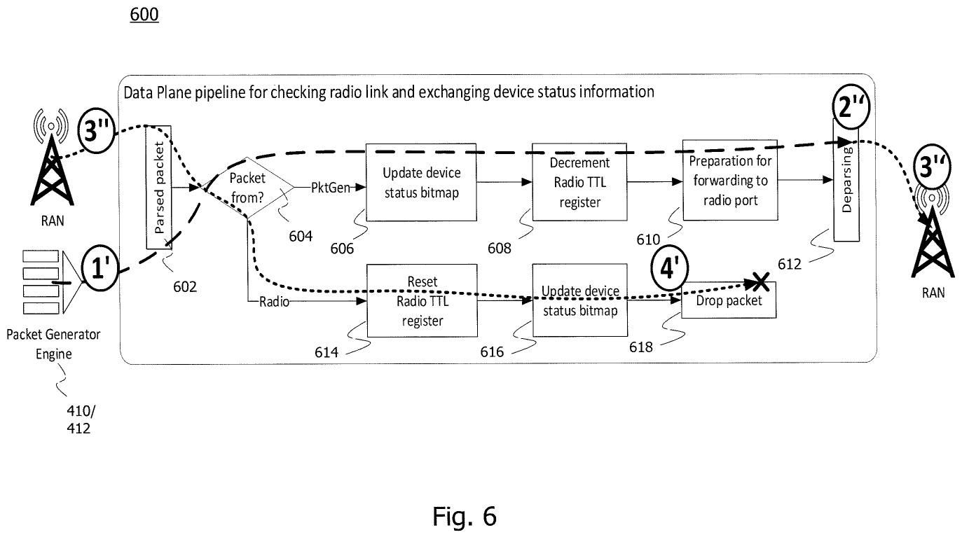

To avoid having to re-transmit packet data over the communication network 105, as explained above with reference to FIGS. 1 to 3B, the apparatus 110 is configured to emulate, from the perspective of the I/O device 102A, the presence of the controller 103, while the apparatus 112 is configured to emulate, from the perspective of the controller 103, the presence of the I/O device 102A so as to reduce the data traffic on the communication network 105. This emulation will now be explained in greater detail with reference to FIG. 4B and FIG. 5. FIG. 4B is based on the exemplary network scenario already discussed above with reference to FIGS. 2 and 4A. FIG. 5 illustrates an associated packet processing pipeline 500 that is operated in real-time.

Each of the apparatus 110 and the apparatus 112 of FIG. 4B is programmed to exe-cute the packet processing pipeline 500 that fulfills two tasks. The first task is the handling of incoming data packets from the local packet source 102A, 103 and the preparation of a response on behalf of the remote message destination 103, 102A, while preventing forwarding the associated packet data via the communication network 105. The second task is the determination of a change, or modification, of the packet data and a corresponding notification of its counterpart apparatus 112, 110 on the other side of the communication network 105 (where previously stored packet data need to be updated, or refreshed).

As illustrated in FIGS. 4B and 5, a packet source (the I/O device 102A in exemplary scenario of FIG. 4B) generates a data packet and transmits it according to the predefined timing previously negotiated with the remote packet destination (the controller 103, such as a PLC, in FIG. 4B). The data packet is intercepted by the apparatus 110/112 in the local domain 100A/100C (step 1 in FIG. 4B, step 342 or 348 in FIG. 3B, step 502 in FIG. 5).

With reference to FIG. 5, the apparatus 110/112 also parses the data packet intercepted in step 502 (e.g., by separating the packet header from packet data) and determines in step 504 that the data packet has arrived from the local domain 100A/100C. As such, the procedure branches to step 506.

In step 506, the apparatus 110/112 gets the device identifier of the packet source (e.g., from the parsed packet header). Then, the apparatus 110/112 calculates a hash over the packet data (step 508 in FIG. 5) and determines whether the calculated hash matches a hash calculated over packet data of a data packet previously received from the same packet source (i.e., having the same device identifier as determined in step 506), see step 510 in FIG. 5 and step 350 in FIG. 3B. The hash over the packet data of the previously received data packet may have been stored in a register (e.g., within the memory 204 of FIG. 2B) in association with the corresponding device identifier and will be looked-up in step 510.

If it is determined instep 510 that the hash has not changed, the data packet is prevented from being forwarded on the communication network 105 towards the packet destination, i.e., the controller 103 in FIG. 4B (step 2 in FIG. 4B and step 352 in FIG. 3B). Rather, the data packet is processed and sent back, or returned, to the packet source, i.e., the I/O device 102A in FIG. 4B (step 3 in FIG. 4B). The returned data packet mimics—timing-wise and content-wise—a data packet expected by the packet source from the packet destination and, thus, prevents the packet source from detecting an error condition that would occur in case a predefined number of data packets are not received as expected by the packet source.

In more detail, the data packet is processed by the apparatus 110/112 such that the processed data packet, upon receipt by the packet source (I/O device 102A in FIG. 4B), mimics a data packet from the packet destination at the expected timing. Due to the real-time processing of the apparatus 110/112 and the fact that the timing has been pre-negotiated between and is applied by both the packet source (the I/O device 102A in FIG. 4B) and the packet destination (the controller 103 in FIG. 4B), returning processed data packets at the rate at which they are received from the packet source ensures that the packets source receives the returned (but processed) data packets at the expected timing and, seemingly, from the packet destination. As such, the apparatus 110/112 does itself not keep track of the timing using a local timer or similar means (although it may do so in an alternative variant not shown in FIG. 5).

In other implementations, the apparatus 110/112 is provided with a timer per I/O 3s device 102A that is set according to the timing negotiated between a given I/O device 102A and the controller 103. Once the timer expires, the expected data packet is generated by the apparatus 110/112 and transmitted to the local packet source (that acts as packet destination for that packet). Upon packet transmission, the timer is re-set and the cycle is repeated. Evidently, packet generation has to take into account any modifications in the packet data generated in the remote domain 100C/100A.

Returning to the scenario illustrated in FIG. 5, processing of a data packet by the apparatus 110/112 prior to returning it to the packet source includes modifying the packet header and the packet payload. The packet header of a ProfiNet-compliant data packet includes, inter alia, a data field called CycleCounter (2 byte) for storing a cycle counter value. From the cycle counter value, an update time (i.e., the timing) of a data packet flow can be determined (update time=31.25 μs×(difference of cycle counter values of two consecutive data packets). Based on the latest data packet arrival time, the expected arrival time of the next data packet from a packet source at a packet destination (from the controller 103 at the I/O device 102A in the scenario of FIG. 4B) can be calculate as the latest data packet arrival time plus the update time of the data packet flow from the packet source.

The apparatus 110/112 maintains a register in memory 204 (see FIG. 2B) that stores a current cycle counter value for the (or each) remote packet source (the controller 103 in FIG. 4B). In step 512, the apparatus 110/112 updates the cycle counter value in the register associated with the remote counterpart of the packet source that triggered the current packet processing procedure and gets (i.e., reads out) the updated cycle counter value

Then, in step 514, the packet header of the data packet to be processed is modified by setting the cycle counter value to the value obtained in step 512 and by setting the device identifier in the packet header to the identifier of the remote counterpart (the controller 103 in FIG. 4B) of the particular packet source (the I/O device 102A in FIG. 4B) that triggered the current packet processing procedure. This identifier may have been looked up in step 512 from a look-up-table (based on the identifier of the local packet source obtained in step 506) to identify the cycle counter register that is to be read out.

Still in step 514, the apparatus 110/112 replaces the packet data in the data packet to be processed with previously received packet data as generated by the remote counterpart (the controller 103 in FIG. 4B). The previously received packet data have been obtained via the communication network 105 from the opposite apparatus 112/110 (having executed steps 342 to 346 of FIG. 3B). In the implementation of FIG. 5, the previously received packet data are stored in a table (e.g., a match-action table) in memory 204 of the apparatus 110/112 (see FIG. 2B), for example in association with the device identifier obtained in step 506.

Then, in step 516, the processed data packet is prepared for being sent back, or returned, to the packet source as the data packet that is expected from the destination. To this end, in some variants, packet source and packet destination addresses are swapped in the packet header, e.g., the Ethernet header in a ProfiNet implementation. Moreover, an output port may be set to be the same as an input port.

From step 516 the procedure passes to step 518 and to a determination if a radio link of the communication network 105 is up. Should this be the case the procedure passes to step 520 and a determination if the respondent (the controller 103 in FIG. 4B) is alive, as will be discussed in greater detail below with reference to FIG. 6. Should the respondent be alive, the procedure passes from step 520 to step 522 where a deparsing operation takes place before the processed data packet is finally returned to the packet source. The deparsing operation assembles the data packet from the modified packet header and the modified packet data. As an alternative to the deparsing operation, or in addition, packet replication, e.g., packet mirroring can be performed in step 522, also depending on the preceding step preceding step 522. In general, a data packet can be dropped (i.e., discarded) or forwarded (e.g., returned) by the apparatus 110/112. Packet replication permits to obtain one or more copies of a data packets (e.g., for being output to different processes).

As indicated by step 3 in FIG. 4B, the packet data previously received via the communication network from a remote domain 100A/100C (and previously forwarded or already re-transmitted to the packet source of the current cycle) will be returned (forwarded or re-transmitted) to the packet source of the current cycle (see step 326 or step 328 in FIG. 3A). The packet source cannot detect that the data packet thus received does not originate from its remote counterpart, but has effectively been generated by the local apparatus 110/112. The processed and returned data packet thus mimics, content-wise and timing-wise, the data packet expected by the packet source from the remote packet destination at the current cycle.

If any of the determinations in steps 518 and 520 is negative, the processed data packet is dropped in step 522. Dropping of the data packet will result in the packet source counting a lost data packet in regard to its remote counterpart, and if a corresponding lost-packet counter at the packet source reaches a predefined value, an error condition is detected (and corresponding actions are taken, such as a stopping of the entire robot cell 101).

FIG. 4C illustrates a scenario in which the packet data in a data packet generated by the packet source change compared to previously transmitted packet data because, for example, new status information becomes available. Therefore, similarly as in the scenario of FIG. 4B, the packet source generates a data packet (step 1 in FIG. 4C), but now with the new packet data. The determination in step 520 of FIG. 5 will thus yield that the hash calculated over the newly received packet data is different from the hash that was calculated (and stored) for a previously received packet. Accord-ingly, the procedure branches to step 526.

In step 526 two actions are triggered in parallel (see branching in step 2′ in FIG. 4C). The first action is a packet replication so that the replicated data packet can be sent, in step 522, by the apparatus 110/112 via the communication network 105 to its remote counterpart apparatus 112/110 (step 346 in FIG. 3B from the perspective of the apparatus 110/112 and step 322 in FIG. 3A from the perspective of its remote counterpart apparatus 112/110). The second action is that the newly received data packet is processed and the processed data packet is either returned to the packet source or dropped, as explained above with reference to steps 512 to 524.

The replicated data packet sent in step 522 then arrives at the remote counterpart apparatus 112/110 and it is determined there that the data packet has arrived via the communication network 105 (i.e., over the radio link), see step 504 in FIG. 5. As such, the procedure “filters out” that data packet and branches to step 528. In step 528 it is determined that the data packet has not been marked with an acknowl-edgement from the control plane (CP-ACK, as explained in greater detail below). From step 528 the procedure thus branches to step 530 to perform preparations for forwarding the data packet from the data plane via a CPU port of the processor 202 (see FIG. 2B) to the control plane of the apparatus 112/110 (step 3′ in FIG. 4C). Those (optional) preparations may include the setting of metadata and the adding of information to the packet header.

From step 530 the procedure continues with step 522. In step 522, the data packet is handed over to the CPU port and output via the CPU port to a PacketIn interface 534 of the control plane (step 532 in FIG. 5).

In step 536 the control plane processing procedure starts and the packet data are extracted from the data packet so that the packet data can be “learned”, and a table, such as a match-action table (as used in step 514), is filled in step 538 with the extracted packet data (see also step 4 in FIG. 4C). As such, the apparatus 112/110 may in future use this packet data upon generating the data packets that are to be returned to its local message source, as explained above with reference to steps 512 to 522 (see also step 7 in FIG. 4C). It is to be noted that control plane processing (“packet filtering” &“packet learning”) can be turned on and off, see step 544.

The control plane processing procedure continues with step 540, in which the data packet is marked with a CP-ACK before being output via a PacketOut interface 542 of the control plane to the CPU port and, from the CPU port, to the data plane (see step 5 in FIG. 4C). In step 550 of FIG. 5, the data plane prepares the marked data packet for being returned, via the communication network 105 (i.e., the radio link), to the apparatus 110/112 that originally received the data packet from its local packet source.

Upon receipt of the marked data packet, the apparatus 110/112 determines in step 528 of FIG. 5 that the data packet has been marked with a CP ACK and, thus, branches to step 546. In step 546, a hash is calculated over the packet data and the resulting hash value is stored in the register associated with the message source (the I/O device in FIG. 4C) to replace the previously stored hash value for use in the com-parison step 510. Then, the data packet is dropped in step 524 (see step 6 in FIG. 4C).

The packet processing pipeline 500 described above with reference to FIG. 5 is specific for cyclically transmitted data packets. Other packets, such as notification packets that will now be discussed with reference to FIGS. 4D and 6, are transparently forwarded by the apparatus 110/112 in step 548

Care has to be taken to ensure that the data traffic reduction over the communication network 105 resulting from installation of the apparatus 110 in the industrial process domain 100A and of the apparatus 112 in the controller domain 100C does not impair failure detection by any of the I/O devices 102A and the controller 103 in the respective domain 100A, 100C. Possible failures may occur in the communication network 105 (e.g., in regard to the radio link) as well as in the I/O devices 102A and the controller 103 and need to be quickly addressed (e.g., to avoid damages in the robot cell 101).

FIGS. 4D and 6 illustrate embodiments of a failure detection mechanism that can be implemented in the context of the embodiments described above. FIG. 4D is again based on the exemplary network scenario already discussed above with reference to FIGS. 2 and 4A to C. FIG. 6 illustrates an associated packet processing pipeline 600 that is operated in real-time.

The packet processing pipeline 600 enables the apparatus 110 in the industrial process domain 100A and the apparatus 112 in the controller domain 100C to exchange status information about the status of the communication network 105 and the availability, or aliveness, of the I/O devices 102A and of the controller 103. If a failure is detected, the automatic data packet generation in the local domain 100A, 100C by the respective apparatus 110, 112 (see FIG. 4B) has to be stopped so as to trigger detection of an error condition by the I/O devices 102A or the controller 103 in view of the outstanding data packets.

In the present embodiment, a data packet received from a particular I/O device 102A by the apparatus 110 in the industrial process domain 100A sets a status bit in a status bitmap register of that apparatus 110. The status bit, when set, is indicative of the aliveness of that I/O device 102A and, when not set, constitutes an error notification. A similar status bitmap register is maintained by the apparatus 112 in the controller domain 100C for the controller 103. The bitmaps are continuously updated (e.g., by un-setting a particular status bits after a certain period of time in which no packet has been received from the expected packet source) and exchanged in notification packets between the apparatus 110 in the industrial process domain 100A and the apparatus 112 in the controller domain 100C. The notification packets will also serve as “connection test messages” for the radio link over the communication network 105. Each notification packet may have a data volume that is less then an aver-age data volume of a regular data packet as generated by the I/O devices 102A and the controller 103.

As illustrated in FIGS. 4D and 6, a notification packet generator engine 410 and 412 is provided as part of the apparatus 110 in the industrial process domain 100A and as part of the apparatus 112 in the controller domain 100C, respectively. This notification packet generator 410, 412 may be realized as a software element, a hardware element or a combination thereof.

In step 1′ of FIGS. 4D and 6, the notification packet generator engine 410, 412 generates a notification packet containing the local status bitmap at a predefined fre-quency. To monitor the status of the communication network 105 (here: the radio link), the apparatus 110 in the industrial process domain 100A and the apparatus 112 in the controller domain 100C each maintain a radio time-to-live (TTL) counter that is decremented by 1 whenever a notification packet is sent.

In the packet processing pipeline 600 of FIG. 6, a newly generated notification packet is parsed by the apparatus 110/112 in step 602, and it is then determined in step 604 if the notification packet has been received from the local generator engine 410/412 or over the radio link via the communication network 105. Assuming that the packet comes from the local generator engine 410/412, a local status bitmap register is read out and the packet data are updated in step 606 based the content of the status bitmap. Moreover, the radio TTL counter is decremented in an associated register in step 608. In case the TTL counter reaches zero, the radio link over the communication network 105 is considered down and the apparatus 110/112 stops returning data packets to the local packet source so as to trigger an error condition (as explained above with reference to FIG. 5). In step 610, the notification packet is prepared for being forwarded to the radio port for transmission via the communication network 105 to the remote apparatus 112/110 (steps 2″ and 3″ in FIG. 4D and on the right-hand side of FIG. 6).

The remote apparatus 112/110 receives the notification packet via the communication network 105 (step 3″ on the left-hand side of FIG. 4D), parses it in step 602 and determines in step 604 that the notification packet has arrived over the communication network 105 (i.e., over the radio link). The procedure then branches to step 614 and (re-)sets the TTL counter to a predefined value (e.g., to 3). Then, a local register storing the status bitmap of the opposite domain 100C/100A is refreshed in step 616 based on the packet data of the notification packet. In case the bitmap indicates that, for example, a particular I/O device 102A is not operative because the associated bit is not set, the remote apparatus 112/110 stops returning data packets to the local patent source, here the controller 103, and for the non-operative I/O device 102A only, as explained above with reference to FIG. 5. Finally, the remote apparatus 112/110 drops the notification packet (see step 4′ in FIGS. 4D and 6 as well as step 618 in FIG. 6).

It is to be noted that the apparatus 110 in the industrial process domain 100A and the apparatus 112 in the controller domain 100C apply the same packet processing pipeline 600 and exchange notification packets asynchronously and independently.

The packet processing pipeline 500 in FIG. 5 may be ramped up and down in dedicated phases. In a first phase, the traffic reduction is not applied at all, meaning that the apparatus 110 in the industrial process domain 100A and the apparatus 112 in the controller domain 100C transparently forward all data packets received from the respective local packet source (see FIG. 4A). In a second phase, the apparatus 110 and the apparatus 112 start storing the packet data from the remote side (“learning phase”) and sending CP-ACKs (see also step 544 in FIG. 5). In a third phase, each apparatus 110, 112 starts filtering out the data packets with unchanged packet data and generating automatic replies towards the local packet source. As such, traffic reduction becomes effective since packet data are only forwarded over the communication network 105 when the packet data have changed. These phases are transited in the reverse order when the packet processing pipeline 500 is to be ramped down.

As has become apparent from the description of exemplary embodiments, the technique presented herein allows the reduction of real-time traffic over a resource-critical link of a communication network 105 interconnecting the industrial process domain 100A and the controller domain 100C. The resource-critical link may be a radio link or a logical connection through a hierarchically organized communication network. The technique may be implemented using symmetrically arranged PPPCs, such as programmable switches.

While the present disclosure has been described with reference to exemplary embodiments, it will be appreciated that the present disclosure can be modified in various ways without departing from the scope of the present disclosure as defined in the appended claims.

1-51. (canceled)

52. A method of handling messages generated in an industrial control procedure by a first device for being transmitted via a communication network towards a second device, wherein the first device is one of a field device and a field device controller and the second device is the other one of the field device and the field device controller, the method comprising:
intercepting a first message generated by the first device, wherein the first message is intercepted before the communication network towards the second device, and wherein the first message has a first message content;
storing the first message content;
forwarding the first message content on the communication network towards the second device;
intercepting at least one second message generated by the first device, wherein the at least one second message is intercepted before the communication network towards the second device, and wherein the at least one second message has a second message content;
determining whether the second message content matches the stored first message content; and
responsive to the second message content matching the stored first message content, preventing the matching message content from again being forwarded on the communication network towards the second device.

53. The method of claim 52, further comprising, responsive to the second message content not matching the stored first message content, forwarding the second message content on the communication network towards the second device.

54. The method of claim 52, wherein the intercepted messages are received from the first device in accordance with a predefined first timing.

55. The method of claim 54, further comprising:
determining, based on the intercepted messages, whether message reception from the first device conforms to the first timing; and
triggering an error condition detection at the second device responsive to the message reception from the first device not conforming to the first timing.

56. The method of claim 52, further comprising:
generating at least one connection test message; and
transmitting the at least one connection test message on the communication network.

57. The method of claim 56, wherein the at least one connection test message is transmitted at least during a period of time in which the matching message content is prevented from being forwarded on the communication network.

58. The method of claim 56, wherein the notification message takes the role of the connection test message.

59. The method of claim 56, wherein the at least one connection test message is transmitted in accordance with the first timing.

60. The method of claim 52, wherein the steps are performed by an apparatus coupled via a fieldbus to the first device.

61. The method of claim 52, wherein determining whether the second message content matches the stored first message content comprises:
calculating a first hash over one of the first message and the first message content;
calculating a second hash over a corresponding one of the second message and the second message content; and
comparing the first hash with the second hash.

62. A method of handling messages generated in an industrial control procedure by a first device for being transmitted via a communication network towards a second device, wherein the first device is one of a field device and a field device controller and the second device is the other one of the field device and the field device controller, wherein the second device is configured to detect an error condition if one or more messages are not received from the first device according to a predefined timing, the method comprising:
intercepting a first message received via the communication network, wherein the first message has a first message content that has been generated by the first device;
storing the first message content;
forwarding the first message content to the second device; and
re-transmitting the stored first message content to the second device in accordance with the timing.

63. The method of claim 62, wherein re-transmitting the first message content compensates for a second message having a second message content matching the first message content not being received via the communication network in accordance with the timing.

64. The method of claim 62, wherein re-transmitting the first message content to the second device results in an output data rate towards the second device being higher than an input data rate on the communication network.

65. The method of claim 62, wherein re-transmitting the first message content comprises re-transmitting the first message or transmitting a new message comprising the first message content.

66. The method of claim 62, wherein the second device is configured to detect the error condition if a number n>1 of successive messages is not received according to the timing.

67. The method of claim 62, further comprising:
receiving, via the communication network, a notification message indicative of message generation by the first device not conforming to the timing; and
causing an error condition detection by the second device.

68. The method of claim 62, further comprising:
monitoring the communication network for receipt of one or more connection test messages; and
causing an error condition detection by the second device in case the one or more connection test messages are not received as expected.

69. The method of claim 62, further comprising:
intercepting a second message received via the communication network, wherein the second message has been generated by the first device and has a second message content;
determining whether the second message content corresponds to the stored first message content; and
responsive to the second message content not corresponding to the stored first message content, stopping re-transmission of the first message to the second device and transmitting the second message content to the second device.

70. A method of reducing resource usage in a communication network used to carry messages from a message source to a message destination:
receiving outgoing messages generated by the message source for the message destination, the outgoing messages generated according to a defined message periodicity and each one containing new or repeated content;
passing individual messages containing new content as new messages for conveyance towards the message destination via the communication network; and
blocking individual messages containing repeated content from entering the communication network.

71. The method of claim 70, further comprising, at the message destination, providing each new message incoming from communication network to the message destination and, to maintain the defined message periodicity at the message destination, substituting for the blocked messages by locally repeating corresponding ones of the new messages for the message destination.
